(19) United States
(12) Patent Application Publication
(10) Pub. No.: US 2021/0076456 A1
(43) Pub. Date: Mar. 11, 2021

(54) A WIRELESS APPARATUS HAVING A PLURALITY OF ESIM ALLOCATED TO DIFFERENT COMMUNICATION NETWORKS

(71) Applicant: Somasundaram Ramkumar, Madurai (IN)

(72) Inventor: Somasundaram Ramkumar, Madurai (IN)

(21) Appl. No.: 17/046,310

(22) PCT Filed: Mar. 14, 2018
(86) PCT No.: PCT/IB2018/051715

§ 371 Date: Oct. 9, 2020

(51) Int. Cl. H04W 88/06; H04M 1/02

(52) U.S. Cl. CPC H04W 88/06; H04M 1/026

(57) ABSTRACT

A wireless apparatus, comprising a mobile phone, tablet, television, notebook, camera, computer, laptop, and an ESIM integrated with the wireless apparatus wherein the wireless apparatus includes a plurality of ESIM is stored in a plurality of memory, each ESIM memory with a plurality of pins, said pins of one or more of the ESIM memory being connected in parallel, and the plurality of memory adapted for storing a plurality of ESIM in order to operate selectively or simultaneously, said plurality of ESIM memory connected to a central processing unit (CPU), in parallel, the CPU connected to one or more of the plurality of ESIM memory through a switching circuit.

The invention relates to a wireless apparatus, comprising a mobile phone, tablet, television, notebook, camera, computer, laptop and other communication devices and a ESIM (Embedded Subscriber Identity Module or Electronic Subscriber Identity Module) integrated with the mobile phone, tablet, television, notebook, camera, computer, laptop and other communication devices in particular.

The object of the invention is a wireless apparatus, comprising a mobile phone, tablet, television, notebook, camera, computer, laptop and other communication devices and a ESIM (Embedded Subscriber Identity Module or Electronic Subscriber Identity Module) integrated with the mobile phone, tablet, television, notebook, camera, computer, laptop and other communication devices, wherein the mobile phone, tablet, television, notebook, camera, computer, laptop includes a plurality of ESIM is stored in a plurality of memory, each ESIM memory with a plurality of pins including an input/output pin, a clock pin, a reset pin, a vcc pin, and a ground pin, said pins of one or more of the ESIM memory being connected in parallel, and the plurality of memory adapted for storing a plurality of ESIM in order to operate selectively and/or simultaneously, said plurality of ESIM memory connected to a central processing unit, CPU (14) in parallel, the CPU connected to one or more of the plurality of ESIM memory through a switching circuit, and wherein functions of the one or more ESIM memory are operated by the CPU (14), the switching circuit, and transreceivers (15) included in the mobile phone, tablet, television, notebook, camera, computer, laptop. The other communication devices is a smartwatch, workstation, wearable mobile, server computer, wearable watch mobile, wearable computer and so on. The circuitry of the mobile phone, tablet, television, notebook, camera, computer, laptop including one or more memory for storing one or more ESIM adapted to transreceive with mobile towers, wherein the functions of the one or more ESIM memory is operated selectively and/or simultaneously by the CPU (14), switching circuit, and transreceivers (15), and the CPU (14) is connected to the transreceivers (15), the output of which is fed to an antenna (16) in the mobile phone, tablet, television, notebook, camera, computer, laptop and the said CPU (14) comprises a plurality of CPU in the mobile phone, tablet, television, notebook, camera, computer, laptop includes a plurality of ESIM memory in order to operate selectively and/or simultaneously. The plurality of ESIM memory with a plurality of pins is connected in parallel is also inbuilt in the CPU (14) in the mobile phone, tablet, television, notebook, camera, computer, laptop. A plurality of bluetooth, plurality of speakers, plurality of microphone, plurality of headphone/earphone jack, plurality of phone calls, plurality of Wi-fi, plurality of messages (SMS, MMS and so on), plurality of display screen, plurality of Wi-fi Hotspot, plurality of transreceivers, plurality of mobile data, plurality of mobile hotspot, plurality of WAP, plurality of GPRS, plurality of audio call, plurality of video Call, plurality of RAM, plurality of ROM, plurality of Keyboard and/or Virtual Keyboard, plurality of memory socket, plurality of Radio, plurality of GPS, plurality of memory chips, plurality of camera, plurality of audio, plurality of video, plurality of television, plurality of audio player and/or recorder, plurality of video player and/or recorder, plurality of antenna and other features is operated by CPU (14) in the mobile phone, tablet, television, notebook, camera, computer, laptop includes a plurality of ESIM memory with a plurality of pins in order to operate selectively and/or simultaneously. The power supply required to operate the plurality of ESIM memory with a plurality of pins is obtained from a battery and/or external power supply in the mobile phone, tablet, television, notebook, camera, computer, laptop. The external power supply may be obtained by providing an external socket which may be fixed in the mobile phone, tablet, television, notebook, camera, computer, laptop. The said mobile phone, tablet, television, notebook, camera, computer, laptop includes a plurality of ESIM memory with a plurality of pins is adapted to operation on a GSM, CDMA or other radio system network. In addition, the said mobile phone, tablet, television, notebook, camera, computer, laptop includes a plurality of ESIM memory with a plurality of pins is operate on any mobile generation network, including 2G (Second Generation), 3G (Third Generation), 4G (Fourth Generation), 5G (Fifth Generation), 6G (Sixth Generation), 7G (Seventh Generation) and so on. In order to incorporate this principle there is a need for technological changes in the existing mobile phone, tablet, television, notebook, camera, computer, laptop. Therefore the entire circuitry of the known mobile phone, tablet, television, notebook, camera, computer, laptop is changed to account for the present invention.

The salient features of the invention are described in detail with reference to various figures showing essential aspects of the invention.

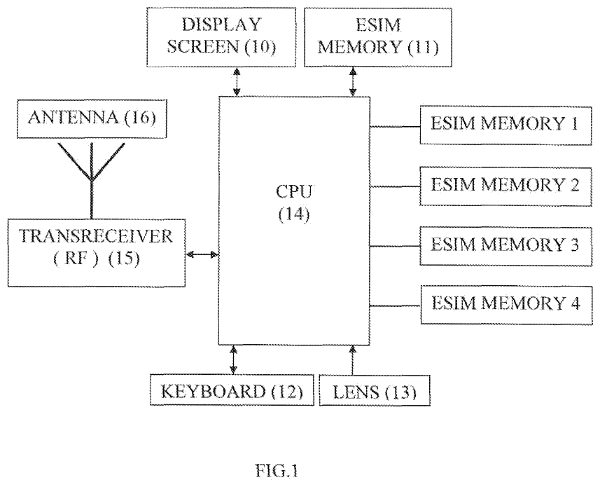

FIG. 1 shows a schematic diagram of the mobile phone, tablet, television, notebook, camera, computer, laptop of the present invention;

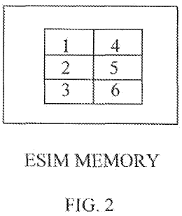

FIG. 2 shows the details of the pins of a ESIM memory:

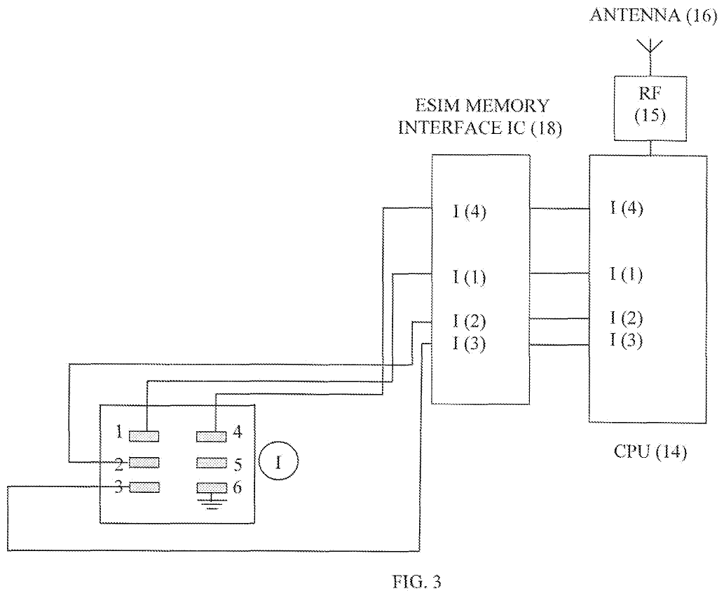

FIG. 3 shows the circuitry of the system having one ESIM memory;

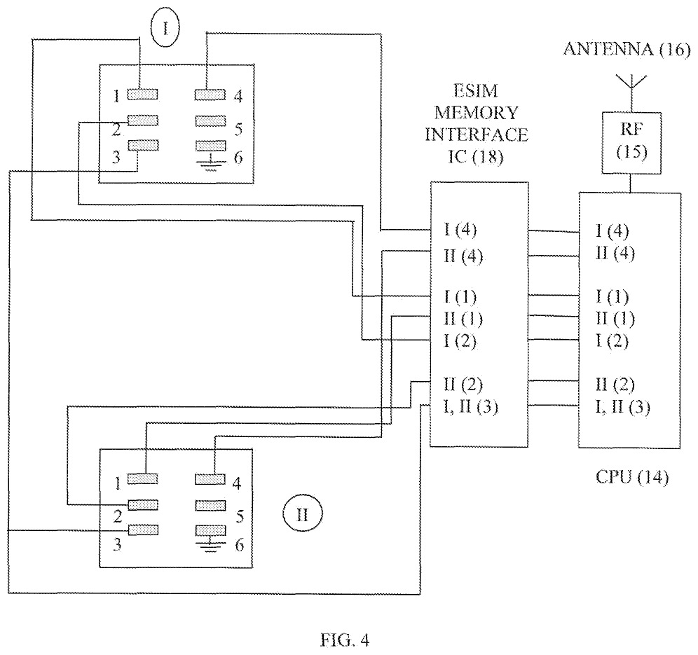

FIG. 4 shows the circuitry of the system having two ESIM memory;

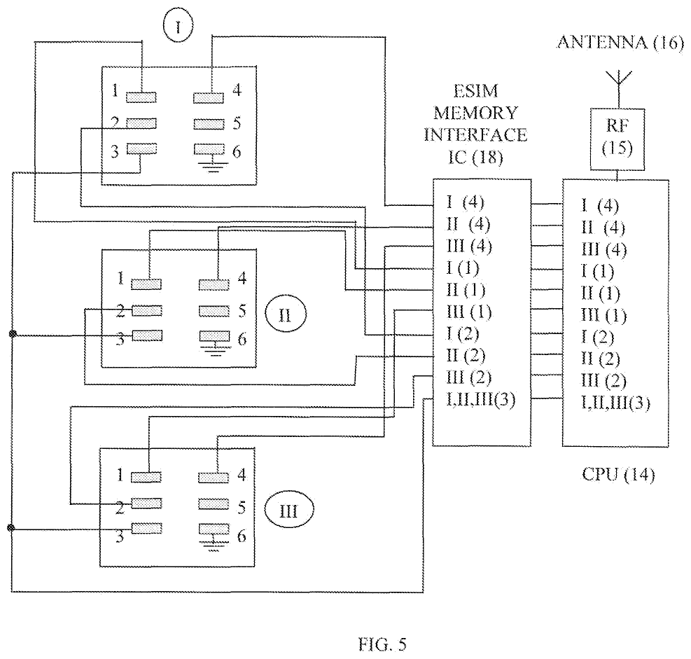

FIG. 5 shows the circuitry of the system having three ESIM memory; and

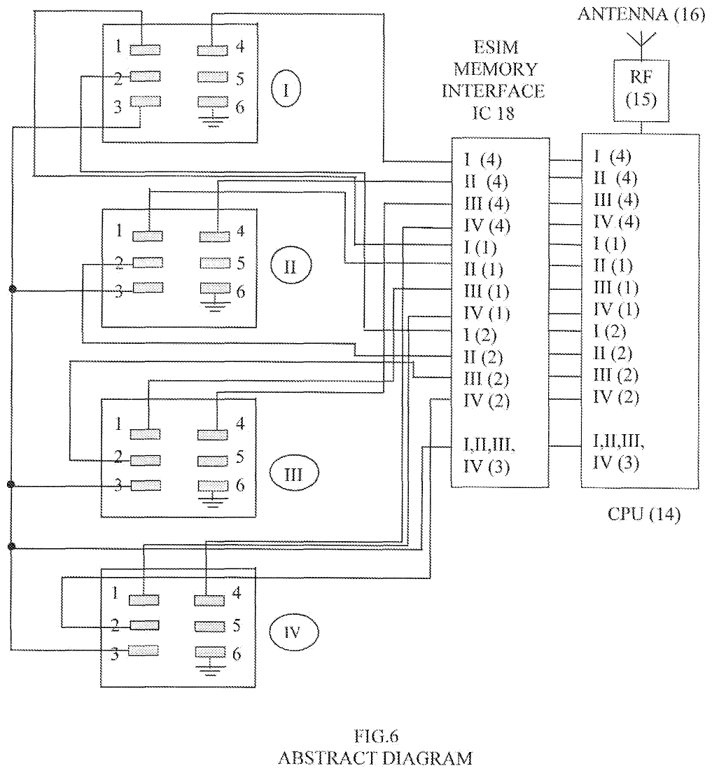

FIG. 6 shows the circuitry of the system having four ESIM memory.

As can be seen in FIG. 1, the mobile phone, tablet, television, notebook, camera, computer, laptop may comprise a Display Screen (10), Keyboard (12) and/or Virtual Keyboard (12), Lens (13), ESIM Memory (11), CPU (14), Transreceiver (15), Antenna (16), and ESIM memory (1,2,3,4).

The Display Screen (10) may be connected to the CPU (Central Processing Unit) (14) for displaying characters, messages, pictures, videos or other information associated with the mobile phone, tablet, television, notebook, camera, computer, laptop includes a plurality of ESIM memory with a plurality of pins in order to operate selectively and/or simultaneously. The Display screen (10) may be LCD (Liquid Crystal Display), LED (Light Emitting Diode) display screen, or any other type of screen. In addition, the Display Screen (10) may also be used for displaying information associated with a telephone call, such as may be received from the mobile tower. This may include a Caller ID number, location of a call, identity of a caller, characters (or) messages, pictures, videos, Menu, SMS messages, MMS messages, FAX transmissions. E-mails, etc. The Display Screen (10) may also be vised for dialing phone numbers, or inputting information by tin user, including using numbers, the alphabets, and abbreviations. The menu may be shown to the user in words (alphabets, numbers) or abbreviations on the Display Screen (10).

The Keyboard (12) and/or Virtual Keyboard (12) may be connected to the CPU (14) for inputting data like letters and numbers. The Keyboard (12) and/or Virtual Keyboard (12) may have keys front numbers ‘0’ to ‘9’ and also may have keys including the alphabets from ‘a’ to ‘z.’ In one embodiment, the keys may include both letters and numbers, such as the case wherein the key with no.2 also includes the alphabets ‘a, b, c’, the key with no.3 also includes the alphabets ‘d, e, f’ and so on. Bused on these arrangements of the keys in the Keyboard (12) and/or Virtual Keyboard (12), the user may have the ability to dial any mobile or telephone number by operating the relevant keys on the Keyboard and/or Virtual Keyboard (12) or send SMS, MMS, FAX, E-mail, etc. by pressing a key. The keys on the Keyboard and/or Virtual Keyboard (12) may allow the user to operate various functions associated with the telephonic features of the mobile phone, tablet, television, notebook, camera, computer, laptop includes a plurality of ESIM memory with a plurality of pins in order to operate selectively and/or simultaneously, such as pressing ‘m’ to enter into the menu function.

The Lens (13) may be designed suitably and can be incorporated in any convenient part of mobile phone, tablet, television, notebook, camera, computer, laptop includes a plurality of ESIM memory with a plurality of pins in order to operate selectively and/or simultaneously. The operation of the lens (13) may be provided by appropriate keys, such as those associated with the Keyboard and/or Virtual Keyboard (12). The Lens (13) may also be connected to the Central Processing Unit (14) for sending signals thereto and receiving commands therefrom. The Lens (13) may be adapted to capture an image, such as an image of an object in proximity to the mobile phone, tablet, television, notebook, camera, computer, laptop includes a plurality of ESIM memory with a plurality of pins in order to operate selectively and/or simultaneously. The lens (13) may be manually operated and/or automatically operated to capture the image, and may capture images of objects at any distance from the mobile phone, tablet, television, notebook, camera, computer, laptop includes a plurality of ESIM memory with a plurality of pins in order to operate selectively and/or simultaneously.

The Memory (11) may be connected to the CPU (14) and can be used to read and write messages and for storing information. Program instructions for operating the features of the mobile phone, tablet, television, notebook, camera, computer, laptop includes a plurality of ESIM memory with a plurality of pins in order to operate selectively and/or simultaneously may be stored in the Memory (11). The menu can be selected by pressing appropriate keys on the Keyboard and/or Virtual Key board and the related instructions of the program can be stored in the memory (11), to be viewed on the Display Screen (10). The menu may be shown to the user in words ( alphabets, numbers ) or abbreviations on the display screen (10).

The CPU (14) may be used to control tie operation of the device. The CPU (14) may include several input and output pins for the various functions associated with the mobile phone, tablet, television, notebook, camera, computer, laptop includes a plurality of ESIM memory with a plurality of pins in order to operate selectively and/or simultaneously. For example, the CPU (14) may send commands to operate the mobile phone, tablet, television, notebook, camera, computer, laptop includes a plurality of ESIM memory with a plurality of pins in order to operate selectively and/or simultaneously. In one embodiment, the CPU (14) may include a plurality of CPUs that may be utilized to control the operation of the device. The ESIM memory may include a plurality of ESIM memory and may be connected to the CPU. In one aspect of the invention, the ESIM memory may be connected in parallel. Information and/or signals from the ESIM memory may be fed to the CPU (14) separately as shown in the FIG. 1. Additionally, an Antenna (16) and Transreceiver (15) may be connected to the CPU (14). In another aspect of the invention, the plurality of ESIM memory with a plurality of pins is connected in parallel is also inbuilt in the CPU (14) in the mobile phone, tablet, television, notebook, camera, computer, laptop.

The Transreceiver (15) may be a radiofrequency (RF) transreceiver. In one aspect, there may be a plurality of transreceivers (15). The transreceiver (15) may be designed for transreceiving mobile signals to and from the mobile tower selectively and/or simultaneously in a mobile phone, tablet, television, notebook, camera, computer, laptop includes a plurality of ESIM memory with a plurality of pins.

The audio associated with a mobile telephone call may be heard through speakers and/or headphone/earphone jack and/or bluetooth in the mobile phone, tablet, television, notebook, camera, computer, laptop includes a plurality of ESIM memory with a plurality of pins in order to operate selectively and/or simultaneously.

In one embodiment, one, some, or all the features of mobile phone, tablet, television, notebook, camera, computer, laptop can be operated by the CPU (14). A plurality of bluetooth, plurality of speakers, plurality of microphone, plurality of headphone/earphone jack, plurality of phone calls, plurality of Wi-fi, plurality of messages (SMS, MMS and so on ), plurality of display screen, plurality of Wi-fi Hotspot, plurality of transreceivers, plurality of mobile data, plurality of mobile hotspot, plurality of WAP, plurality of GPRS, plurality of audio call, plurality of video Call, plurality of RAM, plurality of ROM, plurality of Keyboard and/or Virtual Keyboard, plurality of memory socket, plurality of Radio, plurality of GPS, plurality of memory chips, plurality of camera, plurality of audio, plurality of video, plurality of television, plurality of audio player and/or recorder, plurality of video player and/or recorder, plurality of antenna and other features is operated by CPU (14) in the mobile phone, tablet, television, notebook, camera, computer, laptop includes a plurality of ESIM memory with a plurality of pins in order to operate selectively and/or simultaneously. The CPU (14) may operate these features independently or concurrently. The CPU (14) comprises a plurality of CPU connected to one or more of the plurality of ESIM memory with a plurality of pins in order to operate selectively and/or simultaneously in the mobile phone, tablet, television, notebook, camera, computer, laptop.

The power supply required to operate the plurality of ESIM memory with a plurality of pins is obtained from a battery and/or external power supply in the mobile phone, tablet, television, notebook, camera, computer, laptop. The external power supply may be obtained by providing an external socket which may be fixed in the mobile phone, tablet, television, notebook, camera, computer, laptop.

As can be seen in FIG. 3, a ESIM (Embeded Subscriber Indentity Module or Electronic Subscriber Indentity Module) memory associated with the mobile phone, tablet, television, notebook, camera, computer, laptop may include a plurality of pins. FIG. 3 illustrates a ESIM memory with six pins. In the context of the mobile phone, tablet, television, notebook, camera, computer, laptop of the present invention, the ESIM memory may be connected in parallel. The pin details of the ESIM memory of FIG. 3 are as follows.

1) CLOCK

2) RESET

3) POWER SUPPLY (Vcc)

4) I/O ( DATA )

5) NC (NO CONNECTION)

6) GROUND

FIGS. 4-6 illustrate various embodiments of the connections of the ESIM memory. Each embodiment illustrates one or more ESIM memory I,II,III,IV, a ESIM memory IC or ESIM memory Interface IC (18), a CPU (14), a transreceiver (15) and an antenna (16).

The power supplied for the ESIM memory may emanate from the same source, and therefore the power supply (Vcc) may be common to all the ESIM memory. The Vcc of individual ESIM memory may be interconnected before it is fed to the Interface IC as shown in the FIGS. 4-6. The ground pin (6) of the individual ESIM memory may be interconnected and may be commonly grounded. The “no connection” pin (5) may not be connected to the mobile phone, tablet, television, notebook, camera, computer, laptop. The clock signal (1) from the individual ESIM memory (ESIM memory I, ESIM memory II, ESIM memory III, and ESIM memory IV) may be connected to the ESIM memory interface IC (18) separately (clk I, clk II etc.,). The Input/Output (I/O) data (4) and Reset output (2) from each of the ESIM memory (I,II, etc.) may also be fed to the ESIM memory interface IC (18) separately as shown. The signals from the various ESIM memory may be fed to the CPU (14) through the ESIM memory interface IC (18). The plurality of ESIM memory with a plurality of pins is also separately fed to live CPU (14) directly without ESIM memory interface IC (18). The CPU (14) may also be connected to the transreceivers (15) and through to the Antenna (16). The transreceivers (15) may be adapted for transreceiving signal to/from a plurality of mobile towers selectively and/or simultaneously.

A switching circuit may be placed between the ESIM memory interface IC (18) and the CPU (14). In one aspect, the switching circuit may be a ‘chip’ (i.e. an Integrated Circuit device (IC)) and can be placed between the ESIM memory and CPU (14). The timing of switching may be milliseconds, nanoseconds, or any other increment. By this method of switching among multiple ESIM memory, signals from a plurality of different mobile companies' towers can be transreceived through RF (15).

In another aspect, the switching circuit may be placed between CPU (14) and the transreceiver (15). In this configuration as well, signal from a plurality of different mobile companies' towers can transreceived. The timing of switching may be the same between the switching of RF (15) and ESIM memory in either aspect.

The plurality of ESIM memory with a plurality of pins is connected in parallel is also inbuilt in the CPU (14) in the mobile phone, tablet, television, notebook, camera, computer, laptop.

According to the invention, a wireless apparatus comprising a mobile phone, tablet, television, notebook, camera, computer, laptop is disclosed, having one or a plurality of ESIM memory contains plurality of pins (which may include an Input/Output pin, clock pin, reset pin, vcc pin, ground pin, etc.). The said pins of the one or plurality of ESIM memory may be connected in parallel. The said plurality of memory for storing plurality of ESIM in order to operate selectively and/or simultaneously. The said plurality of ESIM memory may be connected to the CPU (14) in parallel and the said CPU (14) may include the switching circuit. The said CPU (14) may be connected to the one or plurality of ESIM memory through the switching circuit. The function of the one or plurality of ESIM memory may be operated by the CPU (14), the switching circuit and the transreceivers (15).

The circuitry of the mobile phone, tablet, television, notebook, camera, computer, laptop may be modified in order to accommodate utilization of the one or plurality of ESIM memory. The one or plurality of memory may be adapted for storing the one or plurality of ESIM, which are adapted to allow for transreceiving signal from one or more mobile towers. The function of the one or plurality of ESIM memory may be operated selectively and/or simultaneously by the CPU (14), switching circuit, and transreceivers (15). The said CPU (14) may be connected through the transreceiver (15) to the antenna (16) in the mobile phone, tablet, television, notebook, camera, computer, laptop.

The number of ESIM memory included in the mobile phone, tablet, television, notebook, camera, computer, laptop may determine the number of different mobile towers with which the mobile phone, tablet television, notebook, camera, computer, laptop may communicate. For instance, if one ESIM memory with a plurality of pins is provided, then the mobile phone, tablet, television, notebook, camera, computer, laptop may communicate one mobile tower of one mobile service provider. If two ESIM memory with a plurality of pins are provided, then the mobile phone, tablet, television, notebook, camera, computer, laptop may communicate two mobile towers, which may be associated with two different mobile service providers. If three ESIM memory with a plurality of pins are provided, then the mobile phone, tablet, television, notebook, carters, computer, laptop may communicate with three mobile towers, which may be of three different mobile service providers and so on. Therefore the mobile phone, tablet, television, notebook, camera, computer, laptop may communicate with multiple numbers of mobile towers of various mobile service providers, depending on number of ESIM memory with a plurality of pins provided in the mobile phone, tablet, television, notebook, camera, computer, laptop.

The foregoing description of certain embodiments provides the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. While the disclosure presents certain embodiments to illustrate the inventive concepts, numerous modifications, alterations, and changes to the described embodiments are possible without departing from the sphere and scope of the present invention. Accordingly, it is intended that the present disclosure not be limited to the described embodiments, but that it has the full scope defined by the language of the following claims, and equivalents thereof.

I claim:

1) A wireless apparatus, comprising:
(a) a mobile phone, tablet, television, notebook, camera, computer, laptop;
(b) a ESIM ( Embedded Subscriber Identity Module or Electronic Subscriber Identity Module) integrated with the mobile phone; ESIM (Embedded Subscriber Identity Module or Electronic Subscriber Identity Module) integrated with the tablet; a ESIM (Embedded Subscriber Identity Module or Electronic Subscriber Identity Module) integrated with the television; a ESIM (Embedded Subscriber Identity Module or Electronic Subscriber Identity Module) integrated with the notebook; a ESIM (Embedded Subscriber Identity Module or Electronic Subscriber Identity Module) integrated with the camera; a ESIM (Embedded Subscriber Identity Module or Electronic Subscriber Identity Module) integrated with the computer; a ESIM (Embedded Subscriber Identity Module or Electronic Subscriber identity Module) integrated with the laptop.
(c) wherein the mobile plume includes a plurality of ESIM is stored in a plurality of memory, each ESIM memory with a plurality of pins including an input/output pin, a clock pin, a reset pin, a vcc pin, and a ground pin, said pins of one or more of the ESIM memory being connected in parallel, and the plurality of memory adapted for storing a plurality of ESIM in order to operate selectively and/or simultaneously, said plurality of ESIM Memory connected to a central processing unit, CPU (14) in parallel, the CPU (14) connected to one or more of the plurality of ESIM memory through a switching circuit, and wherein functions of the one or more ESIM memory are operated by the CPU (14), the switching circuit, and transreceivers (15) included in the mobile phone.
(d) circuitry of the mobile phone including one or more memory for storing one or more ESIM adapted to trans receive with mobile towers, wherein the functions of the one or more ESIM memory is operated selectively and/or simultaneously by the CPU (14), switching circuit, and transreceivers (15), and the CPU (14) is connected to the transreceivers (15), the output of which is fed to an antenna (16) in the mobile phone,
(e) the mobile phone includes one or plurality of ESIM memory, plurality of bluetooth, plurality of speakers, plurality of microphone, plurality of headphone/earphone jack, plurality of phone calls, plurality of Wi-fi, plurality of messages, plurality of display screen, plurality of Wi-fi Hotspot, plurality of transreceivers, plurality of mobile data, plurality of mobile hotspot, plurality of WAP, plurality of GPRS, plurality of audio call, plurality of video Call, plurality of RAM, plurality of ROM, plurality of Keyboard and/or Virtual Keyboard, plurality of memory socket, plurality of Radio, plurality of GPS, plurality of memory chips, plurality of camera, plurality of audio, plurality of video, plurality of television, plurality of audio player and/or recorder, plurality of video player and/or recorder, plurality of antenna is operated by CPU (14) in the mobile phone,
(f) the said CPU (14) comprises a plurality of CPU connected to one or more of the plurality of ESIM memory with a plurality of pins in order to operate selectively and/or simultaneously in the mobile phone; the plurality of ESIM memory with a plurality of pins is connected in parallel is also inbuilt in the CPU (14) in the mobile phone,
(g) wherein the tablet includes a plurality of ESIM is stored in a plurality of memory, each ESIM memory with a plurality of pins including an input/output pin, a clock pin, a reset pin, a vcc pin, and a ground pin, said pins of one or more of the ESIM memory being connected in parallel, and the plurality of memory adapted for storing a plurality of ESIM in order to operate selectively and/or simultaneously, said plurality of ESIM Memory connected to a central processing unit, CPU (14) in parallel, the CPU (14) connected to one or more of the plurality of ESIM memory through a switching circuit, and wherein functions of the one or more ESIM memory are operated by the CPU (14), the switching circuit, and transreceivers (15) included in the tablet,
(h) circuitry of the tablet including one or more memory for storing one or more ESIM adapted to transreceive with mobile towers, wherein the functions of the one or more ESIM memory is operated selectively and/or simultaneously by the CPU (14), switching circuit, and trans receivers (15), and the CPU (14) is connected to the transreceivers (15), the output of which is fed to an antenna (16) in the tablet,
(i) the tablet includes one or plurality of ESIM memory, plurality of bluetooth, plurality of speakers, plurality of microphone, plurality of headphone/earphone jack, plurality of phone calls, plurality of Wi-fi, plurality of messages, plurality of display screen, plurality of Wi-fi Hotspot, plurality of transreceivers, plurality of mobile data, plurality of mobile hotspot, plurality of WAP, plurality of GPRS, plurality of audio call, plurality of video Call, plurality of RAM, plurality of ROM, plurality of Keyboard and/or Virtual Keyboard, plurality of memory socket, plurality of Radio, plurality of GPS, plurality of memory chips, plurality of camera, plurality of audio, plurality of video, plurality of television, plurality of audio player and/or recorder, plurality of video player and/or recorder, plurality of antenna is operated by CPU (14) in the tablet,
(j) the said CPU (14) comprises a plurality of CPU connected to one or more of the plurality of ESIM memory with a plurality of pins in order to operate selectively and/or simultaneously in the tablet; the plurality of ESIM memory with a plurality of pins is connected in parallel is also inbuilt in the CPU (14) in the tablet.
(k) wherein the television includes a plurality of ESIM is stored in a plurality of memory, each ESIM memory with a plurality of pins including an input/output pin, a clock pin, a reset pin, a vcc pin, and a ground pin, said pins of one or more of the ESIM memory being connected in parallel, and the plurality of memory adapted for storing a plurality of ESIM in order to operate selectively and/or simultaneously, said plurality of ESIM Memory connected to a central processing unit, CPU (14) in parallel, the CPU (14) connected to one or more of the plurality of ESIM memory through a switching circuit, and wherein functions of the one or more ESIM memory are operated by the CPU (14), the switching circuit and transreceivers (15) included in the television.
(l) circuitry of the television including one or more memory for storing one or more ESIM adapted to transreceive with mobile towers, wherein the functions of the one or more ESIM memory is operated selectively and/or simultaneously by the CPU (14), switching circuit, and transreceivers (15), and the CPU (14) is connected to the transreceivers (15), the output of which is fed to an antenna (16) in the television,
(m) the television includes one or plurality of ESIM memory, plurality of bluetooth, plurality of speakers, plurality of microphone, plurality of headphone/earphone jack, plurality of phone calls, plurality of Wi-fi, plurality of messages, plurality of display screen, plurality of Wi-fi Hotspot, plurality of transreceivers, plurality of mobile data, plurality of mobile hotspot, plurality of WAP, plurality of GPRS, plurality of audio call, plurality of video Call, plurality of RAM, plurality of ROM, plurality of Keyboard and/or Virtual Keyboard, plurality of memory socket, plurality of Radio, plurality of GPS, plurality of memory chips, plurality of camera, plurality of audio, plurality of video, plurality of audio player and/or recorder, plurality of video player and/or recorder, plurality of antenna is operated by CPU (14) in the television.
(n) the said CPU (14) comprises a plurality of CPU connected to one or more of the plurality of ESIM memory with a plurality of pins in order to operate selectively and/or simultaneously in the television; the plurality of ESIM memory with a plurality of pins is connected in parallel is also inbuilt in the CPU (14) in the television,
(o) wherein the notebook includes a plurality of ESIM is stored in a plurality of memory, each ESIM memory with a plurality of pins including an input/output pin, a clock pin, a reset pin, a vcc pin, and a ground pin, said pins of one or more of the ESIM memory being connected in parallel, and the plurality of memory adapted for storing a plurality of ESIM in order to operate selectively and/or simultaneously, said plurality of ESIM Memory connected to a central processing unit, CPU (14) in parallel, the CPU (14) connected to one or more of the plurality of ESIM memory through a switching circuit, and wherein functions of the one or more ESIM memory are operated by the CPU (14), the switching circuit, and transreceivers (15) included in the notebook,
(p) circuitry of the notebook including one or more memory for storing one or more ESIM adapted to transreceive with mobile towers, wherein the functions of the one or more ESIM memory is operated selectively and/or simultaneously by the CPU (14), switching circuit, and transreceivers (15), and the CPU (14) is connected to the transreceivers (15), the output of which is fed to an antenna (16) in the notebook,
(q) the notebook includes one or plurality of ESIM memory, plurality of bluetooth, plurality of speakers, plurality of microphone, plurality of headphone/earphone jack, plurality of phone calls, plurality of Wi-fi, plurality of messages, plurality of display screen, plurality of Wi-fi Hotspot, plurality of transreceivers, plurality of mobile data, plurality of mobile hotspot, plurality of WAP, plurality of GPRS, plurality of audio call, plurality of video Call, plurality of RAM, plurality of ROM, plurality of Keyboard and/or Virtual Keyboard, plurality of memory socket, plurality of Radio, plurality of GPS, plurality of memory chips, plurality of camera, plurality of audio, plurality of video, plurality of television, plurality of audio player and/or recorder, plurality of video player and/or recorder, plurality of antenna is operated by CPU (14) in the notebook,
(r) the said CPU (14) comprises a plurality of CPU connected to one or more of the plurality of ESIM memory with a plurality of pins in order to operate selectively and/or simultaneously in the notebook; the plurality of ESIM memory with a plurality of pins is connected in parallel is also inbuilt in the CPU (14) in the notebook.
(s) wherein the camera includes a plurality of ESIM is stored in a plurality of memory, each ESIM memory with a plurality of pins including an input/output pin, a clock pin, a reset pin, a vcc pin, and a ground pin, said pins of one or more of the ESIM memory being connected in parallel, and the plurality of memory adapted for storing a plurality of ESIM in order to operate selectively and/or simultaneously, said plurality of ESIM Memory connected to a central processing unit, CPU (14) in parallel, the CPU (14) connected to one or more of the plurality of ESIM memory through a switching circuit, and wherein functions of the one or more ESIM memory are operated by the CPU (14), the switching circuit, and transreceivers (15) included in the camera,
(t) circuitry of the camera including one or more memory for storing one or more ESIM adapted to transreceive with mobile towers, wherein the functions of the one or more ESIM memory is operated selectively and/or simultaneously by the CPU (14), switching circuit, and transreceivers (15), and the CPU (14) is connected to the transreceivers (15), the output of which is fed to an antenna (16) in the camera,
(u) live camera includes one or plurality of ESIM memory, plurality of bluetooth, plurality of speakers, plurality of microphone, plurality of headphone/earphone jack, plurality of phone calls, plurality of Wi-fi, plurality of messages, plurality of display screen, plurality of Wi-fi Hotspot, plurality of transreceivers, plurality of mobile data, plurality of mobile hotspot, plurality of WAP, plurality of GPRS, plurality of audio call, plurality of video Call, plurality of RAM, plurality of ROM, plurality of Keyboard and/or Virtual Keyboard, plurality of memory socket, plurality of Radio, plurality of GPS, plurality of memory chips, plurality of audio, plurality of video, plurality of television, plurality of audio player and/or recorder, plurality of video player and/or recorder, plurality of antenna is operated by CPU (14) in the camera,
(v) the said CPU (14) comprises a plurality of CPU connected lo one or more of the plurality of ESIM memory with a plurality of pins in order to operate selectively and/or simultaneously in the camera; the plurality of ESIM memory with a plurality of pins is connected in parallel is also inbuilt in the CPU (14) in the camera,
(w) wherein tire computer includes a plurality of ESIM is stored in a plurality of memory, each ESIM memory with a plurality of pins including an input/output pin, a clock pin, a reset pin, a vcc pin, and a ground pin, said pins of one or more of the ESIM memory being connected in parallel, and the plurality of memory adapted for storing a plurality of ESIM in order to operate selectively and/or simultaneously, said plurality of ESIM Memory connected to a central processing unit, CPU (14) in parallel, the CPU (14) connected to one or more of the plurality of ESIM memory through a switching circuit, and wherein functions of the one or more ESIM memory are operated by the CPU (14), the switching circuit, and transreceivers (15) included in the computer,
(x) circuitry of the computer including one or more memory for storing one or more ESIM adapted to transreceive with mobile towers, wherein the functions of the one or more ESIM memory is operated selectively and/or simultaneously by the CPU (14), switching circuit, and transreceivers (15), and the CPU (14) is connected to the transreceivers (15), the output of which is fed to an antenna (16) in the computer,,
(y) the computer includes one or plurality of ESIM memory, plurality of bluetooth, plurality of speakers, plurality of microphone, plurality of headphone/earphone jack, plurality of phone calls, plurality of Wi-fi, plurality of messages, plurality of display screen, plurality of Wi-fi Hotspot, plurality of transreceivers, plurality of mobile data, plurality of mobile hotspot, plurality of WAP, plurality of GPRS, plurality of audio call, plurality of video Call, plurality of RAM, plurality of ROM, plurality of Keyboard and/or Virtual Keyboard, plurality of memory socket, plurality of Radio, plurality of GPS, plurality of memory chips, plurality of camera, plurality of audio, plurality of video, plurality of television, plurality of audio player and/or recorder, plurality of video player and/or recorder, plurality of antenna is operated by CPU (14) in the computer,
(z) the said CPU (14) comprises a plurality of CPU connected to one or more of the plurality of ESIM memory with a plurality of pins in order to operate selectively and/or simultaneously in the computer; the plurality of ESIM memory with a plurality of pins is connected in parallel is also inbuilt in the CPU (14) in the computer,
(i) wherein the laptop includes a plurality of ESIM is stored in a plurality of memory, each ESIM memory with a plurality of pins including an input/output pin, a clock pin, a reset pin, a vcc pin, and a ground pin, said pins of one or more of the ESIM memory being connected in parallel, and the plurality of memory adapted for storing a plurality of ESIM in order to operate selectively and/or simultaneously, said plurality of ESIM Memory connected to a central processing unit, CPU (14) in parallel, the CPU (14) connected to one or more of the plurality of ESIM memory through a switching circuit, and wherein functions of live one or more ESIM memory are operated by the CPU (14), the switching circuit, and transreceivers (15) included in the laptop,
(ii) circuitry of the laptop including one, or more memory for storing one or more ESIM adapted to transreceive with mobile towers, wherein the functions of the one or more ESIM memory is operated selectively and/or simultaneously by the CPU (14), switching circuit, and transreceivers (15), and the CPU (14) is connected to the transreceivers (15), the output of which is fed to an antenna (16) in the laptop,
(iii) the laptop includes one or plurality of ESIM memory, plurality of bluetooth, plurality of speakers, plurality of microphone, plurality of headphone/earphone jack, plurality of phone calls, plurality of Wi-fi, plurality of messages, plurality of display screen, plurality of Wi-fi Hotspot, plurality of transreceivers, plurality of mobile data, plurality of mobile hotspot, plurality of WAP, plurality of GPRS, plurality of audio call, plurality of video Call, plurality of RAM, plurality of ROM, plurality of Keyboard and/or Virtual Keyboard, plurality of memory socket, plurality of Radio, plurality of GPS, plurality of memory chips, plurality of camera, plurality of audio, plurality of video, plurality of television, plurality of audio player and/or recorder, plurality of video player and/or recorder, plurality of antenna is operated by CPU (14) in the laptop, and
(iv) the said CPU (14) comprises a plurality of CPU connected to one or more of the plurality of ESIM memory with a plurality of pins in order to operate selectively and/or simultaneously in the laptop; the plurality of ESIM memory with a plurality of pins is connected in parallel is also inbuilt in the CPU (14) in the laptop.

2) A wireless apparatus, comprising:
a mobile phone including a plurality of ESIM is stored in a plurality of memory, each memory adapted for storing a ESIM adapted to transceive with one or more mobile towers, and each ESIM memory including a plurality of pins; a tablet including a plurality of ESIM is stored in a plurality of memory, each memory adapted for storing a ESIM adapted to transceive with one or more mobile towers, and each ESIM memory including a plurality of pins; a television including a plurality of ESIM is stored in a plurality of memory, each memory adapted for storing a ESIM adapted to transceive with one or more mobile towers, and each ESIM memory including a plurality of pins; a notebook including a plurality of ESIM is stored in a plurality of memory, each memory adapted for storing a ESIM adapted to transceive with one or more mobile lowers, and each ESIM memory including a plurality of pins; a camera including a plurality of ESIM is stored in a plurality of memory, each memory adapted for storing a ESIM adapted to transceive with one or more mobile towers, and each ESIM memory including a plurality of pins; a computer including a plurality of ESIM is stored in a plurality of memory, each memory adapted for storing a ESIM adapted to transceive with one or more mobile towers, and each ESIM memory including a plurality of pins; a laptop including a plurality of ESIM is stored in a plurality of memory, each memory adapted for storing a ESIM adapted to transceive with one or more mobile towers, and each ESIM memory including a plurality of pins.

3) The wireless apparatus of claim 2, wherein the mobile phone comprises a plurality of ESIM memory, and each ESIM memory including a plurality of pins; the tablet comprises a plurality of ESIM memory, and each ESIM memory including a plurality of pins; the television comprises a plurality of ESIM memory, and each ESIM memory including a plurality of pins; the notebook comprises a plurality of ESIM memory, and each ESIM memory including a plurality of pins; the camera comprises a plurality of ESIM memory, and each ESIM memory including a plurality of pins; the computer comprises a plurality of ESIM memory, and each ESIM memory including a plurality of pins; the laptop comprises a plurality of ESIM memory, and each ESIM memory including a plurality of pins.

4) The wireless apparatus of claim 2, wherein each ESIM memory includes a plurality of pins, including an input/output pin, a clock pin, a reset pin, a vcc pin, and a ground pin, said pins of one or more of the ESIM memory being connected in parallel; each of the plurality of memory is adapted for storing a plurality of ESIM in order to operate simultaneously.

5) The wireless apparatus of claim 3, wherein the plurality of ESIM memory are connected to a central processing unit, CPU (14) in parallel, the CPU (14) connected to one or more of the plurality of ESIM memory through a switching circuit, and wherein functions of the one or more ESIM memory are operated by the CPU (14), the switching circuit, and transreceivers (15) included in the mobile phone; the plurality of ESIM memory are connected to a central processing unit, CPU (14) in parallel, the CPU (14) connected to one or more of the plurality of ESIM memory through a switching circuit, and wherein functions of the one or more ESIM memory are operated by the CPU (14), the switching circuit, and transreceivers (15) included in the tablet; the plurality or ESIM memory are connected to a central processing unit, CPU (14) in parallel, the CPU (14) connected to one or more of the plurality of ESIM memory through a switching circuit, and wherein functions of the one or more ESIM memory are operated by the CPU (14), the switching circuit, and transreceivers (15) included in the television; the plurality of ESIM memory are connected to a central processing unit, CPU (14) in parallel, the CPU (14) connected to one or more of the plurality of ESIM memory through a switching circuit, and wherein functions of the one or more ESIM memory are operated by the CPU (14), the switching circuit, and transreceivers (15) included in the notebook; the plurality of ESIM memory are connected to a central processing unit, CPU (14) in parallel, the CPU (14) connected to one or more of the plurality of ESIM memory through a switching circuit, and wherein functions of the one or more ESIM memory are operated by the CPU (14), the switching circuit, and transreceivers (15) included in the camera; the plurality of ESIM memory are connected to a central processing unit, CPU (14) in parallel, the CPU (14) connected to one or more of the plurality of ESIM memory through a switching circuit, and wherein functions of the one or more ESIM memory are operated by the CPU (14), the switching circuit, and transreceivers (15) included in the computer; the plurality of ESIM memory are connected to a central processing unit, CPU (14) in parallel, the CPU (14) connected to one or more of the plurality of ESIM memory through a switching circuit, and wherein functions of the one or more ESIM memory are operated by the CPU (14), the switching circuit, and transreceivers (15) included in the laptop.

6) The wireless apparatus of claim 3, wherein the functions of the one or more ESIM memory is operated selectively and/or simultaneously by the CPU (14), switching circuit, and transreceivers (15), and the CPU (14) is connected to the transreceivers (15), the output of which is fed to an antenna (16) in the mobile phone; the functions of the one or more ESIM memory is operated selectively and/or simultaneously by the CPU (14), switching circuit, and transreceivers (15), and the CPU (14) is connected to the transreceivers (15), the output of which is fed to an antenna (16) in the tablet; the functions of the one or more ESIM memory is operated selectively and/or simultaneously by the CPU (14), switching circuit, and transreceivers (15), and the CPU (14) is connected to the transreceivers (15), the output of which is fed to an antenna (16) in the television; the functions of the one or more ESIM memory operated selectively and/or simultaneously by the CPU (14), switching circuit, and transreceivers (15), and the CPU (14) is connected to the transreceivers (15), the output of which is fed to an antenna (16) in the notebook; the functions of the one or more ESIM memory is operated selectively and/or simultaneously by the CPU (14), switching circuit, and transreceivers (15), and the CPU (14) is connected to the transreceivers (15), the output of which is fed to an antenna (16) in the camera, the functions of the one or more ESIM memory is operated selectively and/or simultaneously by the CPU (14), switching circuit, and transreceivers (15), and the CPU (14) is connected to the transreceivers (15), the output of which is fed to an antenna (16) in the computer; the functions of the one or more ESIM memory is operated selectively and/or simultaneously by live CPU (14), switching circuit, and transreceivers (15), and the CPU (14) is connected to the transreceivers (15), the output of which is fed to an antenna (16) in the laptop.

7) The wireless apparatus of claim 5, wherein the CPU (14) comprises a plurality of CPUs connected to one or more of the plurality of ESIM memory in order to operate selectively and/or simultaneously in the mobile phone; the plurality of ESIM memory with a plurality of pins is connected in parallel is also inbuilt in the CPU (14) in the mobile phone; the CPU (14) comprises a plurality of CPUs connected to one or more of the plurality of ESIM memory in order to operate selectively and/or simultaneously in the tablet; the plurality of ESIM memory with a plurality of pins is connected in parallel is also inbuilt in the CPU (14) in the tablet; the CPU (14) comprises a plurality of CPUs connected to one or more of live plurality of ESIM memory in order to operate selectively and/or simultaneously in the television; the plurality of ESIM memory with a plurality of pins is connected in parallel is also inbuilt in the CPU (14) in the television; the CPU (14) comprises a plurality of CPUs connected to one or more of the plurality of ESIM memory in order to operate selectively and/or simultaneously in the notebook; the plurality of ESIM memory with a plurality of pins is connected in parallel is also inbuilt in the CPU (14) in the notebook; the CPU (14) comprises a plurality of CPUs connected to one or more of the plurality of ESIM memory in order to operate selectively and/or simultaneously in the camera; the plurality of ESIM memory with a plurality of pins is connected in parallel is also inbuilt in the CPU (14) in the camera; the CPU (14) comprises a plurality of CPUs connected to one or more of the plurality of ESIM memory in order to operate selectively and/or simultaneously in the computer; the plurality of ESIM memory with a plurality of pins is connected in parallel is also inbuilt in the CPU (14) in the computer; the CPU (14) comprises a plurality of CPUs connected to one or more of the plurality of ESIM memory in order to operate selectively and/or simultaneously in the laptop; tire plurality of ESIM memory with a plurality of pins is connected in parallel is also inbuilt in the CPU (14) in the laptop.

8) The wireless apparatus of claim 1, wherein, the transreceiver is adapted to transreceive signal from a plurality of different mobile service provider towers by selectively and/or simultaneously the plurality of ESIM memory, wherein at least two of the plurality of ESIM memory contain data of different mobile service providers in the mobile phone; the said mobile phone is adapted to operate on a GSM or CDMA network, and wherein the said mobile phone is further adapted to operate on a 2G, 3G, 4G, 5G, 6G or 7G network; the transreceiver is adapted to transreceive signal from a plurality of different mobile service provider towers by selectively and/or simultaneously the plurality of ESIM memory, wherein at least two of the plurality of ESIM memory contain data of different mobile service providers in the tablet; the said tablet is adapted to operate on a GSM or CDMA network, and wherein the said tablet is further adapted to operate on a 2G, 3G, 4G, 5G, 6G or 7G network; the transreceiver is adapted to transreceive signal from a plurality of different mobile service provider towers by selectively and/or simultaneously the plurality of ESIM memory, wherein at least two of the plurality of ESIM memory contain data of different mobile service providers in the television; tire said television is adapted to operate on a GSM or CDMA network, and wherein the said television is further adapted to operate on a 2G, 3G, 4G, 5G, 6G or 7G network; the transreceiver is adapted to transreceive signal from a plurality of different mobile service provider lowers by selectively and/or simultaneously the plurality of ESIM memory, wherein at least two of the plurality of ESIM memory contain data of different mobile service providers in the notebook; the said notebook is adapted to operate on a GSM or CDMA network, and wherein the said notebook is further adapted to operate on a 2G, 3G, 4G, 5G, 6G or 7G network; the transreceiver is adapted to transreceive signal from a plurality of different mobile service provider towers by selectively and/or simultaneously the plurality of ESIM memory, wherein at least two of the plurality of ESIM memory contain data of different mobile service providers in the camera; the said camera is adapted to operate on a GSM or CDMA network, and wherein the said camera is further adapted to operate on a 2G, 3G, 4G, 5G, 6G or 7G network; the transreceiver is adapted to transreceive signal from a plurality of different mobile service provider towers by selectively and/or simultaneously the plurality of ESIM memory, wherein at least two of the plurality of ESIM memory contain data of different mobile service providers in the computer; the said computer is adapted to operate on a GSM or CDMA network, and wherein the said computer is further adapted to operate on a 2G, 3G, 4G, 5G, 6G or 7G network; the transreceiver is adapted to transreceive signal from a plurality of different mobile service provider towers by selectively and/or simultaneously the plurality of ESIM memory, wherein at least two of the plurality of ESIM memory contain data of different mobile service providers in the laptop; the said laptop is adapted to operate on a GSM or CDMA network, and wherein the said laptop is further adapted to operate on a 2G, 3G, 4G, 5G, 6g or 7G network.

9) The wireless apparatus of claim 1, wherein, further including speakers and/or headphone/earphone jack and/or Bluetooth, and wherein the speakers and/or headphone/earphone jack and/or Bluetooth are adapted to transmit the audio of the mobile phone includes a plurality of ESIM memory with a plurality of pins in order to operate selectively and/or simultaneously; further including speakers and/or headphone/earphone jack and/or Bluetooth, and wherein the speakers and/or headphone/earphone jack and/or Bluetooth are adapted to transmit the audio of the tablet includes a plurality of ESIM memory with a plurality of pins in order to operate selectively and/or simultaneously; further including speakers and/or headphone/earphone jack and/or Bluetooth, and wherein the speakers and/or headphone/earphone jack and/or Bluetooth are adapted to transmit the audio of the television includes a plurality of ESIM memory with a plurality of pins in order to operate selectively and/or simultaneously; further including speakers and/or headphone/earphone jack and/or Bluetooth, and wherein the speakers and/or headphone/earphone jack and/or Bluetooth are adapted to transmit the audio of the notebook includes a plurality of ESIM memory with a plurality of pins in order to operate selectively and/or simultaneously, further including speakers and/or headphone/earphone jack and/or Bluetooth, and wherein the speakers and/or headphone/earphone jack and/or Bluetooth are adapted to transmit the audio of the camera includes a plurality of ESIM memory with a plurality of pins in order to operate selectively and/or simultaneously; further including speakers and/or headphone/earphone jack and/or Bluetooth, and wherein the speakers and/or headphone/earphone jack and/or Bluetooth are adapted to transmit the audio of the computer includes a plurality of ESIM memory with a plurality of pins in order to operate selectively and/or simultaneously; further including speakers and/or headphone/earphone jack and/or Bluetooth, and wherein the speakers and/or headphone/earphone jack and/or Bluetooth are adapted to transmit the audio of the laptop includes a plurality of ESIM memory with a plurality of pins in order to operate selectively and/or simultaneously.

10) A wireless apparatus, comprising:
a mobile phone including a plurality of ESIM is stored in a plurality of memory, each memory adapted for storing a ESIM adapted to transceive with one or more mobile towers, and each of the ESIM memory including a plurality of pins, and further including a ESIM memory integrated with the mobile phone; a tablet including a plurality of ESIM is stored in a plurality of memory, each memory adapted for storing a ESIM adapted to transceive with one or more mobile towers, and each of the ESIM memory including a plurality of pins, and further including a ESIM memory integrated with the tablet; a television including a plurality of ESIM is stored in a plurality of memory, each memory adapted for storing a ESIM adapted to transceive with one or more mobile towers, and each of the ESIM memory including a plurality of pins, and further including a ESIM memory integrated with the television; a notebook including a plurality of ESIM is stored in a plurality of memory, each memory adapted for storing a ESIM adapted to transceive with one or more mobile towers, and each of the ESIM memory including a plurality of pins, and further including a ESIM memory integrated with the notebook; a camera including a plurality of ESIM is stored in a plurality of memory, each memory adapted for storing a ESIM adapted to transceive with one or more mobile towers, and each of the ESIM memory including a plurality of pins, and further including a ESIM memory integrated with the camera; a computer including a plurality of ESIM is stored in a plurality of memory, each memory adapted for storing a ESIM adapted to transceive with one or more mobile towers, and each of the ESIM memory including a plurality of pins, and further including a ESIM memory integrated with the computer; a laptop including a plurality of ESIM is stored in a plurality of memory, each memory adapted for storing a ESIM adapted to transceive with one or more mobile towers, and each of the ESIM memory including a plurality of pins, and further including a ESIM memory integrated with the laptop.
